(19) United States
(12) Patent Application Publication
(10) Pub. No.: US 2017/0361263 A1
(43) Pub. Date: Dec. 21, 2017

(54) USE OF COATINGS MADE FROM AQUEOUS POLYMER DISPERSIONS HAVING A CORE/SHELL STRUCTURE FOR CAPTURING VOLATILE ORGANIC COMPOUNDS SUCH AS ALDEHYDES

(71) Applicant: Arkema France, Colombes (FR)

(72) Inventors: Alain BOONE, Verderonne (FR); Chantal ROIDOT, PARIS (FR); Patricia BEURDELEY, Montmorency (FR); Frederic FOURNIER, Paris (FR)

(21) Appl. No.: 15/535,479

(22) PCT Filed: Dec. 3, 2015
(86) PCT No.: PCT/FR2015/053311

§ 371 Date: Jun. 13, 2017

(30) Foreign Application Priority Data
Dec. 22, 2014 (FR) 1463089

(51) Int. Cl. B01D 53/02; C08F 2/24; C08F 265/06

(52) U.S. Cl. CPC B01D 53/02; C08F 265/06; C08F 2/24; B01D 2257/708; B01D 2253/202

(57) ABSTRACT

The invention concerns a method comprising the steps of irreversibly capturing and trapping at least one organic volatile compound bearing a function among aldehyde, ketone, or amine, using an aqueous polymer dispersion of core/shell structure particles having an MFFT of 0 to 50° C., with the polymer phase P1 being a hard core with a Tg1 of 60 to 120° C. and the polymer phase P2 being a soft shell with a Tg2 of −20 to 40° C. and with
P1, comprising a monomer M1 with two polymerisable ethylenic unsaturations and an ethylenically unsaturated monomer M2 bearing a carboxylic acid/anhydride function and
P2, representing 40% to 85% by weight of P1+P2 and comprising in its structure units from at least one monomer M3 bearing a polymerisable ethylenic unsaturation and, in addition, a ureido functional group or a functional group having a mobile hydrogen alpha to a ketonic carbonyl.

The present invention concerns the use of a specific aqueous polymer dispersion, in particular said polymer derived from this dispersion, which dispersion has polymer particles of core/shell structure with respective hard/soft polymer phases, to irreversibly capture and trap volatile organic compounds such as aldehydes, ketones or amines, and in particular said aldehyde compounds and more particularly formaldehyde. Said polymer of said dispersion, bearing reactive functional groups with said volatile organic compounds, can be used for this capture, in particular in Indoor air of a room, in the form of film or coating derived from said dispersion, preferably in the form of varnish or paint, more preferably in the form of interior paint. The objective is to reduce the level of said volatile compounds by means of irreversible trapping and more particularly by purifying indoor air of buildings, in particular homes or workplaces where said volatile organic compounds (VOCs) or products can be present from various sources.

In the field of paints, in particular decorative paints, improving air quality is an important matter to consider when developing new products. Measurements of the level of volatile organic compounds in air are taken and associated with specific labels or regulations in each country. By means of the coating, an action of capturing or of capturing and trapping volatile organic molecules can decrease the levels of certain volatile organic compounds in indoor air, such as aldehydes, ketones or amines, and in particular the capturing of aldehyde compounds and more particularly formaldehyde. The polymer used according to the present invention has the role of binder in the coatings and comprises at least one function reacting irreversibly with the functions of said volatile organic materials, in particular aldehydes.

WO 2008/073212 discloses the use of polymers functionalised with acetoacetate groups for coating a filter for trapping aldehydes. The polymers disclosed are polycondensation polymers such as polyesters or polymers in aqueous dispersion obtained by polymerisation in emulsion but with unstructured polymer particles.

EP 2496649 discloses film-forming compositions in aqueous dispersion or in solution in a solvent, including an agent capable of trapping formaldehyde, said agent being selected from active-methylene compounds. Said additive is not grafted onto a polymer but is soluble or dispersed in said composition.

WO 2014/191573 discloses a binder for coatings including a polymer bearing a function that binds formaldehyde by reacting with the formaldehyde present in air. Said polymer can be a polyester, alkyd, polyurethane, polyamide, polyacrylate, polyvinyl alcohol or epoxy resin. It also discloses a method for purifying air using a coating based on said binding. Example 2 of this document discloses the preparation of an acrylic polymer binder in emulsion and functionalised with acetoacetoxy groups, but does not disclose the performance at all. This document in no way discloses or suggests the use of a specific polymer dispersion with structured particles.

EP 2808038 discloses paints or varnishes for purifying air by binding formaldehyde with as main feature the presence of a binder bearing a function that binds formaldehyde by reaction with the formaldehyde in air. However, there is no more detailed specification of said binding, other than it can be an alkyd or an acrylic polymer. The paint compositions disclosed are insufficient in terms of the nature, composition and structure of said binder used in the examples (no name or feature provided).

WO 2012/078886 discloses a method for reducing the level of aldehyde on a substrate or near a substrate by applying on said substrate an aldehyde reduction composition comprising functionalised amine compounds of various types (primary, secondary, tertiary or complex amine). According to variants of this method, the composition can further comprise a film-forming polymer or another compound with an acetoacetyl group or with said film-forming polymer (in addition to said amine compounds) comprising an acetoacetyl group, and according to another variant said polymer can be dispersed in water. No aqueous polymer dispersions with particles of core/shell structure are disclosed or suggested by that document for improving the performance of said binder.

However, the most similar aqueous dispersions disclosed in the state of the art for this use are unstructured and need better performance, first in terms of the efficient capture of said compounds to be captured, in particular aldehydes such as formaldehyde. Even more particularly, the performance of the coating itself must be sufficient and good, in particular in terms of homogeneous and reproducible film-forming and in terms of the absence of blocking after film-forming, with no defect of film-forming or tack on the film obtained.

The present invention shows in particular the importance and the advantage of the specific morphology of the polymer particle and of the concentration of the functions enabling the formaldehyde capture via irreversible reaction in the continuous phase derived from the film obtained from polymer particles of core/shell structure with respective hard/soft phases P1/P2.

The function enabling the reaction with the functions of the volatile organic compounds to be captured irreversibly via reaction, in particular aldehydes, is provided by a functional monomer bearing a functional group among an ureido group or a group having a mobile hydrogen alpha to a ketonic carbonyl, also called an “active methylene” group, such as a diacetone group or an acetoacetoxy group and must be present exclusively in the soft phase P2 which must also be the continuous phase during the formation of the film upon drying with a % by weight of at least 40% and up to 85%, and preferably this soft phase P2 being a majority by weight in relation to the hard phase P1, i.e., with the polymer phase P2 representing more than 50% and up to 85% of the total weight P1+P2.

The functions of said polymer enabling the reaction with the functions of said organic volatile compounds, in particular aldehyde functions, are thus more concentrated and more accessible in the soft shell phase P2, because it can be much softer (according to the Fox Tg) than is acceptable in an unstructured particle (no core/shell structure), if not it becomes very tacky. Thus, the capture of the organic volatile compound in question and in particular aldehydes and more particularly formaldehyde will thus be significantly improved thereby and more important, as is shown by the present invention in the experimental section, compared with the use of a polymer dispersion representative of the state of the art mentioned above (unstructured dispersion).

The object of the present invention is the use of an aqueous polymer dispersion, in particular the polymer derived from said dispersion, to irreversibly capture and trap at least one organic volatile compound bearing a function among aldehyde, ketone or amine, preferably a volatile organic compound bearing an aldehyde function, with said dispersion having a minimum film-forming temperature (MFFT) of 0 to 50° C., preferably 0 to 40° C., measured according to the standard ISO 2115 and comprising polymer particles of hard core P1/soft shell P2 structure, with:
P1 being the hard polymer phase in the core of said particle, with a glass transition temperature Tg1 of 60 to 120° C., preferably 60 to 100° C., and said phase P1 comprising in its structure units from at least one monomer M1 having at least two copolymerisable ethylenic unsaturations and having a cross-linker function and units from at least one ethylenically unsaturated monomer M2 bearing at least one carboxylic acid and/or carboxylic anhydride function,
P2 being the soft polymer phase in the shell having a glass transition temperature Tg2 of −20 to 40° C., preferably −20 to 30° C., more preferably −20 to 20° C. with P2 representing 40% to 85% and preferably more than 50% and up to 85% by weight of the total weight of P1+P2 and comprising in its structure units from at least one monomer M3 bearing a polymerisable ethylenic unsaturation and in addition a ureido functional group or a functional group having a mobile hydrogen alpha to a ketonic carbonyl.

The Tg values of the polymers P1 (Tg1) and P2 (Tg2) are calculated using Fox's law (or relationship), according to the following precise relationship (1):

1/Tg=Σᵢxᵢ/Tgᵢ. (1)

with Tg being the value to be calculated of the glass transition temperature of the polymer considered, in ° K
xᵢ: fraction by weight in said polymer of the monomer component i with Σᵢ xᵢ=1
Tgᵢ: glass transition temperature in ° K of the homopolymer of said monomer i.

Said volatile organic compounds according to the present invention have a boiling temperature (or boiling point) at atmospheric pressure below 250° C. and preferably below 100° C.

Said functional group of said monomer M3 is selected preferably from the groups ureido, acetoacetoxy or diacetone.

More particularly, said monomer M3 is selected from diacetone acrylamide (DAAM), acetoacetoxyethyl (meth)acrylate (AAEM), acetoacetoxypropyl (meth)acrylate (AAPM) or N-(2-(meth)acryloyloxyethyl) ethylene urea (or ureidoethyl (meth)acrylate: UMA), in particular acetoacetoxyethyl (meth)acrylate (AAEM) and diacetone acrylamide (DAAM) and more particularly acetoacetoxyethyl (meth)acrylate (AAEM).

According to another preferred option, the level of said monomer M3 bearing said functional group, preferably diacetone, acetoacetoxy or ureido, more preferably acetoacetoxy or diacetone and even more preferably acetoacetoxy, varies from 50 to 1000 and preferably from 100 to 700 mmol per kg of said polymer (P1+P2). Said monomer M3 is present in said phase P2 at a level of 1% to 25% by weight, preferably 2.5% to 25% by weight and more preferably 5% to 15% by weight relative to the total weight of P1+P2.

According to a particularly preferred option, said phase P2 further comprises at least one transfer agent selected from hydrophilic mercaptans, in particular bearing an ionic group. As an example of such an agent, mention may be made of mercaptopropionic acid.

Even more particularly, said phase P2 comprises at least a second transfer agent selected from hydrophobic mercaptans having a weight ratio of hydrophilic agent to hydrophobic agent greater than 1 and preferably greater than 1.5. The overall level of said first and second transfer agents can represent from 0.02% to 2% by weight and preferably from 0.05% to 1.5% by weight relative to the total weight of the phases P1+P2. As an example of a hydrophobic transfer agent, mention may be made of n-dodecylmercaptan.

The glass transition temperatures Tg1 and Tg2 are calculated according to Fox's law. In particular, the difference between said Tg1 and Tg2 varies from 20 to 140° C. and preferably from 30 to 115° C.

Said monomers M1 and M2 of the phase P1 can represent an overall level of 0.5% to 10% by weight and preferably 1% to 8% by weight of the total weight of the phase P1 with said monomer M2 representing 0.1% to 5% by weight and preferably 0.2% to 4% by weight of said phase P1. More particularly, said polymer phase P1 consists of a seed polymer P0 and a complementary polymer P′1, meaning complementary to P0 to give P1, with the composition of said phase P0 being devoid of said monomers M1 and M2 and with, on the remainder of the monomer composition (apart from M1 and M2), it being possible for the compositions of P0 and P′1 to be identical or different. The overall composition of the phase P1 corresponds to the average composition between P0 and P′1.

The monomer M1 of the phase P1 can be selected from the following monomers:
monofunctional or polyfunctional altylic esters derived from α,β-unsaturated carboxylic or dicarboxylic acids such as allyl (meth)acrylate, monoallyl or diallyl maleate, monoallyl or diallyl tetrahydrophthalate, or polyfunctional allylic esters of saturated di- or polycarboxylic acids such as diallyl phthalate, triallyl trimesate or other polyallylic monomers, such as triallyl cyanurate
polyfunctional (meth)acrylic esters having a functionality of at least 2, such as polyalkylene glycol di(meth)acrylates, such as ethylene glycol di(meth)acrylate, tripropylene glycol di(meth)acrylate, diethylene glycol di(meth)acrylate, di(meth)acrylates of alkylene diols or polyols, preferably with alkylene from C₂ to C₈, such as 1,6-hexanediol di(meth)acrylate, 1,3-butylene glycol di(meth)acrylate, 1,4-butanediol di(meth)acrylate, neopentyl glycol di(meth)acrylate, trimethylol propane tri(meth)acrylate, and
polyvinylbenzenes, such as divinylbenzene or trivinylbenzene,
divinyltoluenes,
divinylnaphthalenes.

The preferred monomers according to M1 are allyl (meth)acrylate, butanediol di(meth)acrylate, hexanediol di(meth)acrylate.

The monomer M2 of the phase P1 can be selected from (meth)acrylic, fumaric, maleic, itaconic, vinylbenzoic, crotonic or isocrotonic acids and/or anhydrides thereof and preferably methacrylic acid (MAA) and/or acrylic acid (AA). AA and MAA are the most preferred.

According to a particular variant, the phase P2 can further comprise at least one monomer M2 as defined above for the phase P1, with respective levels of M2 by weight in the phases P1 and P2 selected such that the weight ratio of the level of M2 in P1 to the level of M2 in P2 varies from 1:1 to 1:10 and preferably from 1:2 to 1:8.

Said phase P2 can comprise, in addition, at least a monomer M4 bearing in addition to the polymerisable ethylenic unsaturation at least one functional group selected from: hydroxy, amine, oxirane, phosphates, phosphonates or phosphinates, amide, sulphate or sulphonate, imide, aziridine, oxazoline or imidazol, provided that the choice of the monomers M4 is made so as to avoid a reaction between the various groups of the monomers M4 or between the groups of the monomers M4 and the groups of the other monomers. As suitable examples of the monomers M4, the following can be given:
hydroxy, such as borne by hydroxyalkyl (meth)acrylates with alkyl from C₂ to C₄ (such as HEMA, HPMA),
amine, such as borne by aminoalkyl (meth)acrylates or aminoalkyl (meth)acrylamides, for example dimethylaminoethyl methacrylate (DMAEMA) or tert-butylaminoethyl methacrylate (TBAEMA),
oxirane, such as borne by glycidyl (meth)acrylate (such as GlyMA),
phosphates, phosphonates or phosphinates, such as borne by the phosphates or phosphonates or phosphinates of hydroxyl alkyl (meth)acrylates and of ethoxylated and/or propoxylated hydroxy alkyl (meth)acrylate, amide, such as (meth)acrylamide,
sulphate and sulphonate, such as borne by (meth)acrylates of hydroxyalkylsulphonates (such as methacrylates of hydroxyethyl sulphonate) or (meth)acrylamides of hydroxyalkyl sulphonates (such as acrylamide propanesulphonic acid) and the salts thereof or
imide, such as maleimide or
aziridine, such as borne by 1-(2-hydroxyethyl) aziridine methacrylate or
oxazoline or imidazol, such as borne by 2-ethyl(2-oxo-imidazolidin-1-yl) methacrylate,
   provided that the choice of these monomers M4 is made so as to avoid a reaction or an interaction between groups during the synthesis which would render the latter impossible between the various groups of the monomers M4 or between the groups of the monomers M4 and the groups of the other monomers.

Concerning the structure of the monomers (or composition of the monomer) of the phases P1 and P2, they can either be based on purely acrylic monomers and thus on a pure acrylic structure (“acrylic” here meaning both acrylic and/or methacrylic) or else be based on a mixed structure which can comprise in P1 or P2, but preferably in P1 (hard phase), vinylaromatic monomers, more particularly styrene and/or derivatives thereof such as vinyltoluenes or else vinylbenzene and preferably styrene and/or vinyltoluenes. More particularly, P1 can comprise such vinylaromatic monomers. According to another variant the phase P1 alone is purely acrylic, and according to another variant the phase P2 alone is purely acrylic, and according to a third variant the two phases P1 and P2 are purely acrylic and consequently said dispersion too is purely acrylic.

The most preferred variants of the dispersion of the invention correspond to:
a phase P1 comprising vinylaromatic monomers with a phase P2 being purely acrylic, the dispersion being in this case of the styrene-acrylic type or
a purely acrylic dispersion for P1 and P2.

Said phase P1 can comprise, and preferably comprises, a seed polymer P0, with P0 devoid of the monomers M1 and M2 as defined above, with said phase P0 representing from 2% to 25% by weight and preferably from 5% to 20% by weight of the weight of said phase P1. More particularly, the phase P1 is obtained before said phase P2, which phase P2 is obtained by polymerisation of the monomers corresponding to this polymer phase at a temperature below or equal to, and preferably below, Tg1 as defined above. Even more preferably, the temperature (for the polymerisation of P2) is at least 5 degrees below Tg1.

According to a variant in this use, said dispersion can comprise in dispersion with the polymer particles at least one compound comprising at least one hydrazine or hydrazide function. According to a preferred option, said dispersion does not comprise such reactive additives for said use.

Preferably, said volatile organic compound to be captured or trapped has a boiling point at atmospheric pressure below 250° C., more preferably below 100° C. More particularly, said volatile organic compound to be captured or trapped is an aldehyde among the C₁ to C₈ aldehydes, which can be saturated or unsaturated, and in particular among formaldehyde (sometimes formalin or formol), acetaldehyde, propanal, acrolein (acrylaldehyde), butanal, pentanal, hexanal, heptanal or octanal, preferably formaldehyde, acetaldehyde, acrolein, hexanal and more preferably formaldehyde.

According to a variant of the present invention, said use concerns the polymer derived from said dispersion as defined above and said polymer is in film form or in coating form and in particular in varnish or paint form, more particularly in paint form.

The use according to the invention of said dispersion in coating form more particularly concerns the protection and/or decoration of substrates, preferably selected from wood, cardboard, metal, plastic, plaster, concrete, fibre cement, glass.

More particularly, said use is that of the polymer derived from said dispersion as disclosed above and said polymer is used in the form of a thin layer or a coating applied on a substrate, in particular on a porous or fibrous substrate. A suitable porous substrate can be plaster, wallpaper (printed or unprinted) or filter paper or cardboard or wood or fibre-reinforced composite panel. A fibrous substrate can be a fibre fabric or a non-woven fabric, optionally preimpregnated with a thermoplastic polymer. These two types of substrates (porous or fibrous) are characterised in particular by the large specific surface area of said substrate.

According to another variant of use, said polymer derived from said dispersion is used in the form of a qualitative or quantitative probe for detecting said volatile compound, in particular said aldehydes and more particularly formaldehyde.

The use according to the present invention applies in particular to decorative coatings.

It can also apply to industrial protective coatings.

According to a particular preference, the use of said polymer dispersion or said polymer derived from said dispersion concerns the capture of said aldehydes, in particular formaldehyde, in the atmosphere in direct contact with the surface of said polymer, more particularly in the form of a thin layer of polymer or coating.

According to another alternative option, said use concerns the capture of the formaldehyde emitted by coatings applied as a sublayer or first layer relative to the capture coating, in particular with said capture coating, derived from said polymer dispersion, being used as a surface coating, i.e., a coating in contact with air.

According to another option, said use concerns the capture of the formaldehyde emitted by a substrate with the latter being coated with a capture coating derived from said polymer dispersion. More particularly, said formaldehyde-emitting substrate can be selected from: pressed wood, sandwich-structured wood or plywood glued together using urea-formaldehyde or melamine-formaldehyde adhesives, treated textile or fibres treated with a formaldehyde-generating treatment composition. Treatment compositions for textiles or fibres can, for example, comprise methylol groups, in particular N-methylol functional groups, generators of formaldehyde emissions.

According to another variant of use according to the present invention, said use concerns the capture of the formaldehyde emitted by a first “generator” substrate, meaning “formaldehyde generator”, and in this case is applied in contact with said “generator” substrate, a second “capture” substrate, meaning “formaldehyde capture”, is impregnated or coated with said aqueous polymer dispersion or is impregnated or coated with the polymer derived from said dispersion. According to this variant, said second “capture” substrate in contact with said first “generator” substrate can be selected from: non-woven fabrics, organic or inorganic fibre fabrics, in particular glass fibre fabrics, for insulating or renovating interior walls.

According to another variant of use according to the present invention, it concerns the impregnation of air filters or smoke filters with said aqueous polymer dispersion. As a particular example of a smoke filter, a cigarette filter can be considered.

The following examples are given as an experimental illustration of the present invention and of its performance, without said examples limiting its scope.

### EXPERIMENTAL SECTION

### 1) Tests Performed: See Table 1 Below

Two dispersions were prepared, one according to the invention (test 1) and one comparative outside the invention (test 2). The dispersion according to the invention of test 1 is comparable to that of test 2 outside the invention, with the difference being the fact that the dispersion according to test 1 has polymer particles of core/shell structure as indicated in table 1 and the dispersion of test 2 is an ordinary dispersion without structured particles, with the composition of the two tests adjusted so as to have the same film-forming temperature with an MFFT of 5° C. The phase P1 in the case of test 1 comprises HDDA as the monomer M1 (2.5% by weight vs P1) and MAA as the monomer M2 (1.6% by weight vs P1).

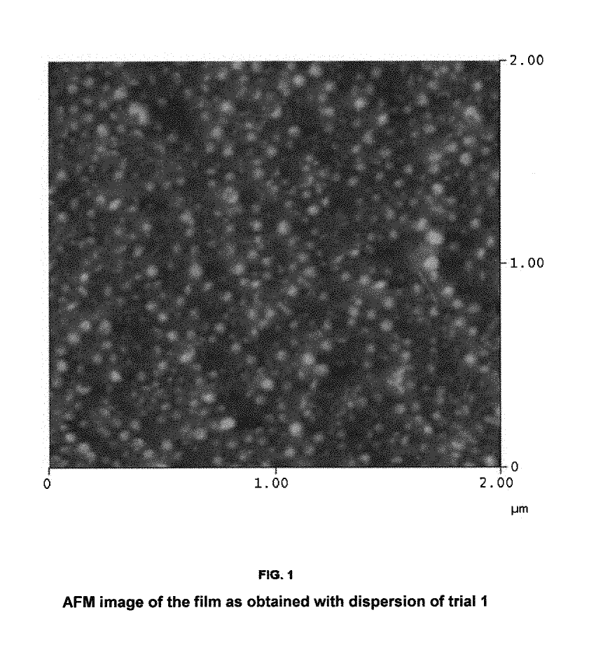

The core/shell structure is shown by atomic force microscopy (AFM) on the film obtained by coalescence of the dispersion of test 1, with the image in FIG. 1 showing the hard phase of the core, appearing as a light area, and the continuous phase coalesced around said cores, corresponding to the shell, appearing as a dark area.

Tack tests (touching with a finger) on the films obtained show that the film obtained with the structured-particle dispersion of test 1 is not tacky and that the film obtained with the dispersion of test 2 is tacky to the touch (after at least 24 hours of drying).

TABLE 1
features of the tests performed

| Test number | 1 | 2 |
|---|---|---|
| Test type | Invention | Outside the invention |
| | | (comparative) |
| % AAEM by weight (monomer M3 | 10* | 10 |
| vs the total weight of the polymer) | | |
| % weight P1 | 40 | — |
| % weight P2 | 60 | — |
| Total | 100 | 100 |
| Fox Tg1 vs P1 (° C.) | 70 | — |
| Fox Tg2 vs P2 (° C.) | −10 | — |
| Overall Fox Tg (° C.) | 17** | −6 |
| MFFT measured by ISO 2115 (° C.) | 5 | 5 |

*16.6% relative to P2
**Overall Tg calculated assuming an unstructured particle with miscible phases P1 and P2

TABLE 2
Raw materials used in the synthesis of the test dispersions 1 and 2

| | Technical | | |
|---|---|---|---|
| Component | function | Chemical nature | Supplier |
| Aerosol ® | Surfactant | Ethoxylated fatty alcohol | Cytec |
| A102 | | sulphosuccinate, | |
| | | sodium salt (C₁₀-C₁₂) | |
| | | 30% solution in water | |
| Disponil ® | Surfactant | Polyglycol ether fatty | Cognis |
| FES 32 | | alcohol sulphate, | |
| | | sodium salt | |
| | | 31% solution in water | |
| Tergitol ® | Surfactant | Secondary ethoxylated | Dow |
| 15S9 | | fatty alcohol | |
| | | with 9 EO, 100% | |
| Emulan ® TO | Surfactant | Ethoxylated fatty alcohol | BASF |
| 4070 | | with 40 EO, 70% | |
| HDDA | Cross-linker | Hexanediol diacrylate | Sartomer |
| | | (HDDA) | |
| BuA | Monomer | Butyl acrylate | Arkema |
| MMA | Monomer | Methyl methacrylate | Arkema |
| AA | Monomer | Acrylic acid | Arkema |
| MAA | Monomer | Methacrylic acid | Arkema |
| AAEM | Cross-linker | Acetoacetoxyethyl | Eastman |
| | | methacrylate | |
| nDDM | Mercaptan | n-Dodecyl mercaptan | Acros |
| MPP | Mercaptan | Mercaptopropionic acid, | Acros |
| | | 80% | |
| Na₂S₂O₈ | Peroxide | Sodium persulphate | Aldrich |
| Na₂S₂O₅ | Reducer | Sodium metabisulphite | Prolabo |
| TBHP | Peroxide | tert-Butyl hydroperoxide, | Aldrich |
| | | 70% | |
| SFS | Reducer | Sodium formaldehyde | Bruggeman |
| | | sulphoxylate | |
| NaOH | Neutralisation | Sodium hydroxide | Prolabo |
| Acticide MBS | Biocide | Aqueous solution of | Thor |
| | | methylisothiazolinone | |
| | | (MIT) and | |
| | | benzisothiazolinone | |
| | | (BIT) (2.5% MIT/ | |
| | | 2.5% BIT) | |

All of the calculated Tg values are calculated according to Fox's law, as already indicated in the description.

The Tg values of the homopolymers corresponding to the monomers used, for purposes of calculating Tgs according to Fox's law, are given in ° C. in table 2a) below.

TABLE 2a)
Tgs of the homopolymers of the monomers
used, for Fox's relationship

| Monomer I | Abbreviation | Tg (° C.) |
|---|---|---|
| Acrylic acid | AA | 106 |
| Methacrylic acid | MAA | 228 |
| Butyl acrylate | BuA | −54 |
| Acetoacetoxyethyl methacrylate | AAEM | 18 |
| Methyl methacrylate | MMA | 105 |

The minimum film-forming temperature (MFFT) is measured according to the standard ISO 2115.

The viscosity cited is a Brookfield viscosity at 10 rpm according to the standard ISO 2555.

The dry extract of the aqueous dispersion is measured according to the standard ISO 3251.

Particle size is measured by photon correlation spectroscopy (PSC), using a Beckman Coulter N4+ analyser. The sample is diluted (3 to 5 drops of emulsion in 50 ml of water) in a polystyrene tank using deionised water on a 0.22 μm acetate filter. Particle size is measured at a temperature of 25° C., a measurement angle of 90° and a laser wavelength of 633 nm.

The AFM image is formed on an instrument: AFM Nanoscope IIIa (Veeco Digital Instruments) in tapping mode on film obtained after deposition of a drop of aqueous dispersion according to test 1, diluted 1:100 on a mica flake, and drying for at least 24 hours under at room temperature.

### 2) Protocol for Test 1

### Materials Used

A jacketed 3-litre (internal capacity) glass reactor, equipped with efficient agitation (vortex), triple-flux refrigerant, a control unit and regulation of the temperature of the material, is used. The reactor comprises the number of inlets necessary for the separate introduction of the various components and also an inlet dedicated to rendering the unit inert with nitrogen (placed under inert nitrogen atmosphere). Leak-tightness is confirmed before each synthesis. The apparatus is equipped with a system for controlling the flow rates at which the components are Introduced.

### Preparation of the Initial Load of the Starting Medium

The starting medium consists of 14.1 g of Disponil® FES 32 solubilised in 327 g of demineralised water. The temperature of said medium is brought to 85° C.

### Preparation of the Seed P0

Mix 6.9 g of MMA and 6.9 g of BuA.

### Preparation of the Pre-Emulsion P′1

4.2 g of Aerosol® A102 and 7.1 g of Disponil® FES 32 are dispersed in 44.1 g of demineralised water with good agitation.

The following are added in turn with good agitation:
130.9 g of MMA
18.5 g of BuA
4.2 g of HDDA
2.8 g of MAA

The pre-emulsion thus formed is white and stable and it will be maintained with gentle agitation. It will be used for the synthesis of the particle core P1, consisting of P0 and P′1 (P1=P0+P′1).

### Preparation of the Pre-Emulsion P2

4.2 g of Aerosol® A102 and 9.1 g of Tergitol® 15S9 are dispersed in 74.4 g of water with good agitation. The following are added in turn with agitation:
70 g of MMA
135.7 g of BuA

A stable, white pre-emulsion is obtained. 10% of this pre-emulsion, or 29.3 g, will be withdrawn and used to carry out a seeding prior to the introduction of P2. The following are then added to the pre-emulsion, still with good agitation:
42.4 g of AAEM
8.5 g of AA
1.06 g of MPP
0.08 g of nDDM

This stable, white pre-emulsion, P2, will be used for the synthesis of the particle shell (P2).

### Preparation of the Catalyst Solutions

1.48 g of sodium persulphate is solubilised in 28.2 g of water.
0.42 g of sodium metabisulphite is solubilised in 3.8 g of water.
0.6 g of TBHP (70%) is solubilised in 2.65 g of water.
0.34 g of SFS is solubilised in 8.1 g of water.

### Polymerization Method

### i) Seeding of P0

With the reaction mixture comprising the initial load stable at 85° C., the mixture of MMA and BuA specified above is introduced to seed P0. Once the temperature stabilises, 70% of the sodium persulphate solution is added. The maximum release of energy marks the conclusion of this step, the particle size is about 30 nm and the conversion is above 70%.

### ii) Synthesis of the Core P1

The introduction of the pre-emulsion P′1 lasts 120 minutes, at a polymerisation temperature of 85° C.

iii) Step of Heat Curing and Cooling

The temperature is maintained at 85° C. for 60 minutes. At the conclusion of the heat curing, the reaction medium is cooled to 65° C. The conversion is then near 100%.

### iv) Synthesis of the Shell P2

At 65° C., the seed made up of 29.3 g of a fraction of P2 (without functional monomers or transfer agents) is introduced into the reactor. Mixing is carried out for at least minutes before beginning the separate introductions of:
The remaining 100% of the second pre-emulsion P2
The remaining 30% of the initiator solution (sodium persulphate)
100% of the activator solution (sodium metabisulphite)

During the introductions, which last 150 minutes, the temperature of the medium is maintained at 65° C. This step is followed by a post-curing for 30 minutes at 65° C.

v) Redox treatment

The TBHP and SFS solutions are added at 65° C. over 30 minutes. This redox treatment is followed by a curing at 65° C. for 30 minutes before cooling to room temperature.

### vi) Final Additions

At 30-35° C., the latex is neutralised to pH 8 by adding sodium hydroxide and is post-supplemented with a biocide. It is then filtered through 100 μm fabric. The dry extract is 44.5%.

The final particle size is about 90 nm; the viscosity is below 100 mPa·s; the measured MFFT is 5 SC.

### 3) Protocol for Test 2

### Materials Used

A jacketed 3-litre (internal capacity) glass reactor, equipped with efficient agitation (vortex), triple-flux refrigerant, a control unit and regulation of the temperature of the material, is used. The reactor comprises the number of inlets necessary for the separate introduction of the various components and also an inlet dedicated to rendering the unit inert with nitrogen. Leak-tightness is confirmed before each synthesis. The apparatus is equipped with a system for controlling the flow rates at which the components are introduced.

### Preparation of the Initial Load of the Starting Medium

The starting medium consists of 33 g of Disponil® FES 32 solubilised in 802 g of demineralised water. The temperature of said medium is brought at 85° C.

### Preparation of the Seed P0

Mix 17.9 g of MMA and 17.9 g of BuA.

### Preparation of the Complementary Pre-Emulsion P′

11 g of Aerosol® A102, 29.3 g of Disponil® FES 32 and 23.6 g of Emulan® TO 4070 are dispersed in 316.7 g of demineralised water with good agitation.

The following are added in turn with good agitation:
356 g of MMA
565 g of BuA
110 g of AAEM
11 g of HDDA
5.5 g of MAA
16.5 g of AA

The pre-emulsion P′ thus formed is white and stable and it will be maintained with gentle agitation. It will be used for the synthesis of the polymer particle P, composed of P0 and P′ as defined for this test 2 (P=P0+P).

### Preparation of the Catalyst Solutions

3.9 g of sodium persulphate is solubilised in 73.2 g of water.
1.6 g of TBHP (70%) is solubilised in 6.9 g of water.
0.9 g of SFS is solubilised in 21.1 g of water.

### Polymerisation Method

### i) Seeding of P0

With the reaction mixture comprising the initial load stable at 85° C., the mixture of MMA and BuA specified above is introduced to seed P0. Once the temperature stabilises, 20% of the sodium persulphate solution is added. The maximum release of energy marks the conclusion of this step. The particle size is about 40 nm and the conversion is above 70%.

### ii) Synthesis of the Polymer Particle P (Unstructured)

The introduction of the pre-emulsion P′ lasts 240 minutes, at a polymerisation temperature of 85° C. Jointly, 71.1% of the sodium persulphate solution is introduced at the same time.

iii) Step of Consuming Residual Monomers, Heat Curing and Cooling

After the conclusion of the introduction of the pre-emulsion P′, the remaining 8.9% of the sodium persulphate solution is introduced, still at 85° C. The temperature is maintained at 85° C. for 20 minutes. At the conclusion of the heat curing, the reaction medium is cooled to 65° C. The conversion is then near 100%.

### iv) Redox Treatment

The TBHP and SFS solutions are added at 65° C. over 30 minutes. This redox treatment is followed by a curing at 65° C. for 30 minutes before cooling to room temperature.

### v) Final Additions

At 30-35° C., the latex is neutralised to pH 8 by adding sodium hydroxide and is post-supplemented with a biocide. It is then filtered through 100 μm fabric. The dry extract is 45.5%.

The final particle size is about 90 nm, the viscosity is below 200 mPa·s, the measured MFFT is 5° C.

### 4) Evaluation of Formaldehyde Capture Performance

### 4.1) Test Method

The performance of the product tested to reduce, by capture, the concentration of formaldehyde in indoor air is evaluated using the standard ISO 16000-23. ISO 16000-23 specifies a general laboratory test method for evaluating the reduction of concentration of formaldehyde by sorptive building materials. It is based on the test chamber method as specified in the standard ISO 16000-9, where the test chamber must simulate the parameters of the reference piece.

The sample to be tested is applied with a specific loading factor and placed in a test chamber (the sampling, transport and storage of the samples to be tested and the preparation of the samples to be tested being specified in the standard ISO 16000-11).

Formaldehyde is mixed into the air supply in order to measure the sorption flux and the mass of saturation per unit area. The first is a direct indication of the performance of the samples relative to the reduction of the concentration of formaldehyde at a given moment.

The second (mass of saturation per unit area) relates to the ability of a tested sample to maintain this performance.

In practical terms, at selected time intervals, a known volume of air is withdrawn from the test chamber. The formaldehyde is thus trapped and transformed into a hydrazone derivative by means of a cartridge filled with silica gel impregnated with 2,4-DNPH (2,4-dinitrophenyl hydrazine). The stable hydrazone derivative formed is desorbed with acetonitrile and analysed by HPLC with an ultraviolet detector (the sampling of air and the analysis methods for determining formaldehyde are specified in the standard ISO 16000-3).

The results obtained are then expressed as concentration of formaldehyde inside the chamber in μg/m³ and/or as sorption flux in μg/m² per hour.

The performance of the sample to be tested in its ability to reduce the concentration of formaldehyde is evaluated by comparing the amount of formaldehyde found inside the chamber containing the sample to be tested with that of the empty chamber (with no sample). The formaldehyde consumption FC by said tested sample (in %) can then be calculated (see §5.3 below for definitions of the magnitudes measured).

### 5.2) Operating Conditions

Test parameters in the emission chamber
Chamber volume: 119 litres
Temperature: 23 t 1° C.
Relative humidity: 50±5%
Air change rate: 0.5 h⁻¹
Loading factor. 1 m²/m³

### Sample Preparation

One layer of coating in the wet state (aqueous dispersion) at 100 g/m².

Formaldehyde injection: constant concentration inside the chamber throughout the duration of the test with a mean concentration inside the chamber of 78 μg/m³.

### Method of Analysis:

Method: ISO 16000-23, EN ISO 16000-3
Principle: HPLC-UV
Formaldehyde detection limit: 3 μg/m³
Uncertainty of detection/analysis of formaldehyde by HPLC-UV detector: ±22%.

### 5.3) Results

The results of formaldehyde consumption (FC) are presented in table 3 below. The formaldehyde consumption FC (in %) is calculated using the following formula:

FC=(Cᵢₙₗₑₜ−C_{chamber})/Cᵢₙₗₑₜ

with the definitions of Cᵢₙₗₑₜ and C_{chamber} being the same as those below for calculating sorption flux F.

TABLE 3
Formaldehyde consumption FC (%)

Duration

| Ref sample | 4 hours | 8 hours | 1 day | 7 days |
|---|---|---|---|---|
| Test 1 | 76 | 56 | 42 | 26 |
| Test 2 | 36 | 15 | 18 | 2 |

The sorption flux F of formaldehyde results are presented in table 4 below:

The sorption flux F is calculated according to the following formula:

F=(Cᵢₙₗₑₜ−C_{chamber})*Qc/A

### With:

F: sorption flux in μg/m² per hour FC: formaldehyde consumption in %, as defined above
Cᵢₙₗₑₜ: concentration at the chamber inlet, in μg/m³
C_{chamber}: concentration inside the chamber, in μg/m³
Qc: flow of formaldehyde-mixed air inside the chamber=0.06 m³/h
A=0.119 m², representing the surface area of the sample (coating)

TABLE 4
Sorption flux F of formaldehyde (in μg/m² per hour)

Duration

| Ref sample | 4 hours | 8 hours | 1 day | 7 days |
|---|---|---|---|---|
| Test 1 | 31 | 23 | 18 | 8 |
| Test 2 | 15 | 6 | 8 | 1 |

1. A method for capturing organic volatile compounds, said method comprising the steps of irreversibly capturing and trapping at least one organic volatile compound bearing a function among aldehyde, ketone or amine, using an aqueous polymer dispersion having a minimum film-forming temperature (MFFT) of 0 to 50° C., measured according to the standard ISO 2115 and comprising polymer particles of hard core P1/soft shell P2 structure, with
P1 being the hard polymer phase in the core of said particle, with a glass transition temperature Tg1 of 60 to 120° C., and said phase P1 comprising in its structure units from at least one monomer M1 having at least two copolymerisable ethylenic unsaturations and having a role of cross-linker and units from at least one ethylenically unsaturated monomer M2 bearing at least one carboxylic acid and/or carboxylic anhydride function
P2 being the soft polymer phase in the shell having a glass transition temperature Tg2 of −20 to 40° C., with P2 representing 40% to 85% by weight, of the total weight of P1+P2 and comprising in its structure units from at least one monomer M3 bearing a polymerisable ethylenic unsaturation and, in addition, an ureido functional group or a functional group having a mobile hydrogen in alpha position to a ketonic carbonyl.

2. The method of claim 1, wherein said functional group of said monomer M3 is selected from the group consisting of ureido, acetoacetoxy and diacetone.

3. The method of claim 1 wherein said monomer M3 is selected from the group consisting of diacetone acrylamide (DAAM), acetoacetoxyethyl (meth)acrylate (AAEM), acetoacetoxypropyl (meth)acrylate (AAPM), N-(2-(meth)acryloyloxyethyl) ethylene urea (or ureidoethyl (meth)acrylate: UMA).

4. The method of claim 1 wherein that the level of said monomer M3 bearing said functional group varies from 50 to 1000 mmol per kg of said polymer (P1+P2).

5. The method of claim 1 wherein said monomer M3 is present in said phase P2 at a level of 1% to 25% by weight relative to the total weight of P1+P2.

6. The method of claim 1 wherein said phase P2 further comprises at least one transfer agent selected from hydrophilic mercaptans bearing an ionic group.

7. The method of claim 1 wherein said phase P2 comprises at least a second transfer agent selected from hydrophobic mercaptans having a weight ratio of hydrophilic agent to hydrophobic agent greater than 1.

8. The method of claim 1 wherein the overall level of said first and second transfer agents represents 0.02% to 2% by weight relative to the total weight of the phases P1+P2.

9. The method of claim 1 wherein the difference between said Tg1 and Tg2 varies from 20 to 140° C. and preferably from 30 to 115° C.

10. (canceled)

11. (canceled)

12. (canceled)

13. (canceled)

14. The method of claim 1 wherein said dispersion comprises in dispersion with the polymer particles at least one compound comprising at least one hydrazine or hydrazide function.

15. The method of claim 1 wherein said volatile organic compound to be captured or trapped has a boiling point at atmospheric pressure below 250° C.

16. The method of claim 1 wherein said volatile organic compound to be captured or trapped is a C₁ to C₈ aldehyde selected from the group consisting of formaldehyde, acetaldehyde, propanal, acrolein (acrylaldehyde), butanal, pentanal, hexanal, heptanal and octanal.

17. The method of claim 1 comprising polymer derived from said dispersion, wherein said polymer is in film or coating form.

18. The method of claim 1 comprising polymer derived from said dispersion, wherein said polymer is used in the form of a thin layer or a coating applied on a porous or fibrous substrate.

19. The method of claim 1 comprising polymer derived from said dispersion, wherein said polymer is used in the form of a qualitative or quantitative probe for detecting said volatile compound.

20. (canceled)

21. (canceled)

22. The method of claim 1 comprising capturing in the atmosphere in direct contact with the surface of polymer derived from said dispersion which is in the form of a thin layer of polymer or coating.

23. The method of claim 1 comprising capturing formaldehyde emitted by coatings applied as a sublayer or first layer relative to the capture coating, with said capture coating being used as a surface coating.

24. The method of claim 1 comprising capturing formaldehyde emitted by a substrate which is coated or impregnated with a capture coating derived from said polymer dispersion.

25. The method of claim 24 wherein said formaldehyde-emitting substrate is selected from the group consisting of: pressed wood, sandwich-structured wood and plywood glued together using urea-formaldehyde adhesives, sandwich-structured wood and plywood glued together using melamine-formaldehyde adhesives, treated textile and fibres treated with a formaldehyde-generating treatment composition.

26. The method of claim 1 comprising capturing formaldehyde emitted by a first “generator” substrate on which is applied in contact, a second “capture” substrate Impregnated or coated with said aqueous polymer dispersion or with the polymer derived from said dispersion.

27. The method of claim 26 wherein said second “capture” substrate in contact with said first “generator” substrate is selected from: non-woven fabrics, organic fibre fabrics, and inorganic fibre fabrics, for insulating or renovating interior walls.

28. The method of claim 1 further comprising the step of impregnating air filters or smoke filters with said aqueous polymer dispersion.
